(19) United States
(12) Patent Application Publication
(10) Pub. No.: US 2018/0010308 A1
(43) Pub. Date: Jan. 11, 2018

(54) SEMI RIGID JOINT

(71) Applicant: Somjit Mandal, Kolkata (IN)

(72) Inventor: Somjit Mandal, Kolkata (IN)

(21) Appl. No.: 15/520,362

(22) PCT Filed: Jul. 1, 2016
(86) PCT No.: PCT/IN2016/000172

§ 371 Date: Apr. 19, 2017

(30) Foreign Application Priority Data
Jul. 3, 2015 (IN) 728/KOL/2015

(51) Int. Cl. F16C 11/12; E04H 12/18

(52) U.S. Cl. CPC E01F 9/627; F16C 11/12; E04H 12/18

(57) ABSTRACT

The present invention discloses a semi rigid joint for flexibly joining various links/structures. The said semi rigid joint comprises plurality of joining elements wherein each said joining element supporting at one end at least one joining component and at its other end having a magnetic connector such that the two adjacent placed joining elements facing said respective magnetic connectors under magnetic attraction of respective magnetic connectors provide a magnetic joint to connect together the components carried at its other ends. A flexible spring means is also proved in cooperation with the magnetic joint to allow bending at said magnetic joint under any external impact/force exceeding the magnetic attraction of the magnets and on release of said external impact/force rejoining the joints under restored magnetic attraction.

### FIELD OF THE INVENTION

The present invention relates to auto reconstructing as well as versatile shock absorbing joint between two links. More specifically, the present invention is directed to develop a Semi Rigid Joint which loses its rigidity temporarily during shock absorption and after absorbing each shock it regains its previous shape and rigidity.

### BACKGROUND OF THE INVENTION

The coupling or joint is particularly directed to uses where it is desired to have a connection between two links or structures. For example, joints for connecting barriers with base, road divider with the road surface, electric pole or rod/pole for traffic signs or banner with a ground structure.

Now the above mentioned joints which connect two links or structures are prone to external force or shock and if the external force or shock exceeds the joints rigidity (force resistance capacity) then these joints are break or deformed plastically.

The available shock absorbing joints between two links or structures are either rigid or flexible. During shock absorption such rigid shock absorbing joint breaks itself or causes permanent damage if the external force or shock exceeds the joints force resistance capacity, whereas flexible joint produces unwanted vibration or oscillation while handling a variation of small load. Also the available shock absorbing joints are designed to absorb shock come from a particular direction.

Thus there has been a need for developing a new low cost yet effective coupling or joint for connecting two links or structures which will it regains its previous shape as well as rigidity, holding exactly the same position like before receiving the external shock or force without undergoing any plastic deformation or breakage. Also, in normal condition or while handling a variation of smaller load (less than a certain external force which exceeds its rigidity) the developed coupling or joint should behaves like a rigid body. Another need was to develop a coupling or joint for connecting two links or structures which will absorbs the shock and avoid impact load come from any direction (except along its axis) by bending after getting flexible.

### OBJECT OF THE INVENTION

It is thus the basic object of the present invention is to develop an auto reconstructing as well as versatile shock absorbing joint between links or structures to built shock proof barrier and unbreakable electric pole, rod/pole for traffic signs or banner.

Another object of the present invention is to develop an auto reconstructing as well as versatile shock absorbing joint between links or structures with semi-rigid property which would be adapted to lose its rigidity temporarily during shock absorption period or when effected by a certain external force which exceeds its rigidity and after absorbing each shock or when the external force is removed or reduced it regains its previous shape as well as rigidity, holding exactly the same position like before without undergoing any plastic deformation or breakage.

Another object of the present invention is to develop an effective semi-rigid coupling or joint for connecting two links or structures which would be adapted to behaves like a rigid body in normal condition or while handling a variation of smaller load less than a certain external force which exceeds its rigidity.

Yet another object of the present invention is to develop an effective semi-rigid coupling or joint for connecting two links or structures which would be adapted to absorb the shock and simultaneously avoid the impact load come from any direction by bending after getting flexible.

Yet another object of the present invention is to develop an effective semi-rigid coupling or joint for connecting two links or structures which would be low cost and easy to manufacture.

### SUMMARY OF THE INVENTION

Thus according to the basic aspect of the present invention there is provided a Semi rigid connector for flexibly joining various links/structures comprising

plurality of joining elements;
each said joining element supporting at one end at least one joining component and at its other end having a magnetic connector such that the two adjacent placed joining elements facing said respective magnetic connectors under magnetic attraction of respective magnets provide a magnetic joint to connect together the components carried at its other ends;
at least one flexible spring means in cooperation with said magnetic joint allowing bending at said magnetic joint under any external impact/force exceeding the magnetic attraction of the magnetic connectors and on release of said external impact/force rejoining the joints under restored magnetic attraction of said magnetic connectors.

According to another aspect in the present Semi rigid connector, the magnetic connectors comprises bipolar magnetic connector oriented such that on release of the external impact/force the bent magnetic joint regains its original orientation and connected position.

According to a further aspect in the present Semi rigid connector, each said bipolar magnetic connector comprises a combination of magnets disposed side by side with their opposite poles facing each other such that the outwardly facing bi-poles of the bipolar magnetic connector face opposite attracting poles of the other connecting bipolar magnetic connector.

According to yet another aspect in the present Semi rigid connector, each said combination of the bipolar magnetic connector of the each magnetic connector comprise a pair of north and south poled magnets facing respective opposite poles obtained of single piece or multiple pieces of magnets integrally provided as a unitary piece two separate pieces of magnets with respective north and south poles facing each other in reverse orientation.

According to a further aspect in the present Semi rigid connector, each of the joining elements comprises

an open end having connector provision for releasable connection/securing to a connecting component/structure;
a closed end having said magnetic connector obtained of one or more permanent magnet or a combination of magnet and magnetic material;
connecting elements comprising at least a first and a second of said joint elements which are connected under magnetic attraction of said magnetic connector at its respective closed ends and at least one spring connection at said closed ends under magnetic attraction.

According to a further aspect in the present Semi rigid connector, each of the joining elements comprises

an open end having an externally connectable provision preferably grooved/threaded portion and an internally connectable provision preferably grooved/threaded socket or holes;
a closed end having said magnetic connector;
said first and second joint elements connectable by cooperative attraction of said respective magnetic connectors at the respective closed end and said cooperative spring attachment between said first and second joining elements wherein said spring element operatively flexibly connecting the joint at the closed end of said joining elements being provided internally and/or externally with respect to said closed end magnets.

According to a further aspect in the present Semi rigid connector, the connectable provisions at the open ends of the joint elements are used to fix the joint with external structures or links.

According to a further aspect in the present Semi rigid connector, the magnetic connectors are oriented to prevent any slip through joining surface.

According to yet another aspect in the present Semi rigid connector, the flexible spring means connecting said joining elements are either internally connected to the joining elements or externally connected to the joining elements with cooperative connecting means in the respective joining elements.

According to yet another aspect in the present Semi rigid connector, for internally supporting the said flexible spring means between the joining elements the spring is centrally disposed within a concentrically disposed centrally open magnetic connectors of the respective joining elements and secured to a hook/support plate internally disposed and wherein for externally supporting the said flexible spring means between the joining elements the spring means surrounds the joining elements externally and is supported externally from the body of the joining elements, one end of the spring connected to one of the joining element and the other end of the spring connected to the other joining element.

According to yet another aspect in the present Semi rigid connector, comprising internal spring based semi rigid joint structure comprising of

magnet holder sockets attached with detachable internally threaded or grooved socket of the open ends of each joint elements facing towards the close ends by screw threading opposite to their socket face;
magnets with two different poles facing each other retained in the magnet holder sockets of the joint elements;
hooks attached with an internal transverse rod or screwed into surface opposite to the open end of the internal transverse plate of the internally threaded or grooved sockets of the open ends of each joint elements;
a spring surrounded by the magnets connecting said hooks to provide the closed ends having said magnets with two different poles retained in the magnet holder sockets temporarily fixed to each other by involving the magnetic force of attraction at initial state.

According to yet another aspect in the present Semi rigid connector, comprising external spring based semi rigid joint structure comprising of

side sockets at the closed ends of each joint elements;
magnets with different poles facing each other retained in the side sockets of the closed ends;
spring end holder or clip attachment on each side sockets;
a spring with two ends grasped by said spring end holders surrounding the magnets to provide the closed ends having said magnets with two different poles retained in the side sockets temporarily fixed to each other by involving the magnetic force of attraction at initial state.

According to another aspect in the present Semi rigid connector, comprising means for building variable tension in the cooperative flexible spring depending upon the nature and/or article of the joint.

According to another aspect in the present Semi rigid connector, comprises a screw with a ball socket joint slideably attached with the internal transverse plate to provide sliding motion to any of the hooks along the screw axis either in outward direction to increase tension of the spring or inward direction to decrease tension of the spring.

According to a further aspect in the present Semi rigid connector, comprises compound Semi Rigid Joint structure by assembling two or more internal spring based semi rigid joint structure or external spring based semi rigid joint structure or their combination.

According to another aspect in the present Semi rigid connector, the closed ends of the two joining elements temporarily fixed to each other by involving the magnetic force of attraction detached from each other upon application of certain external force or shock on the joint exceeding its rigidity or force resistance capacity and gets flexible by losing its rigidity as the magnets get separated and the spring extends to absorb the force or shock;

said spring gets compressed to regain its previous shape and the magnetic force of attraction fixes the joint elements rigidly upon removal of the external force or shock.

According to another aspect in the present Semi rigid connector, the rigidity of the joint can be increased by increasing the magnetic attraction force and/or compressive force of the spring.

The features and advantages of certain embodiments of the present Semi rigid connector will be more readily appreciated when considered in conjunction with the accompanying drawings. The drawings are not to be construed as limiting any of the preferred embodiments.

### BRIEF DESCRIPTION OF THE ACCOMPANYING DRAWINGS

FIG. 1 shows side view of different components of an internal spring semi rigid joint (a) and their sectional views (b) in accordance with the present invention.

FIG. 2 shows side view of rigid state (initial state) (a) and flexible state (b) of an internal spring semi rigid joint.

FIG. 3 shows sectional view of rigid state (initial state) (a) and flexible state (b) of an internal spring semi rigid joint.

FIG. 4 shows side view of different components of an external spring semi rigid joint (a) and their sectional views (b).

FIG. 5 shows side view of rigid state (initial state) (a) and flexible state (b) of an external spring semi rigid joint.

FIG. 6 shows sectional view of rigid state (initial state) (a) and flexible state (b) of an external spring semi rigid joint.

FIG. 7 shows sectional view of rigid state (initial state) (a) and flexible state (b) of a modified internal spring semi rigid joint.

FIG. 8 shows sectional view of internal spring semi rigid joint before and after applying external force (a) and under force condition (b).

FIG. 9 shows different types of magnets applicable for semi rigid joint.

FIG. 10 shows different side views of a semi rigid joint whose two main parts are different in size and shape; where (a), (b) and (c) are the front view, left view and top view respectively.

FIG. 11 shows side view of rigid state (initial state) (a) and flexible state (b) of a compound semi rigid joint.

### DETAILED DESCRIPTION OF THE INVENTION WITH REFERENCE TO THE ACCOMPANYING DRAWINGS

As described hereinbefore, the present invention discloses an auto reconstructing as well as versatile shock absorbing joint or connector between two links or structures. The joint/connector advantageously involves both magnetic force of attraction and elastic strength of a spring to absorb the shock. The joint is semi rigid i.e. it loses its rigidity temporarily during shock absorption and after absorbing each shock it regains its previous shape and rigidity. The said semi rigid connector for flexibly joining various links/structures comprises plurality of joining elements wherein each said joining element supporting at one end at least one joining component and at its other end having magnetic connector such that the two adjacent placed joining elements facing said respective magnetic connectors under magnetic attraction to provide a magnetic joint which connect together the joining elements having the joining components. A flexible spring means is also provided in cooperation with the magnetic joint to elastically connect the joining elements when they are separated under any external impact/force exceeding the magnetic attraction of the magnetic connector and allowing bending at said magnetic joint said external impact/force and on release of said external impact/force rejoining the joints under restored magnetic attraction of the magnetic connectors.

The basic embodiment of the present semi rigid joint comprises a first joint element and a second joint element wherein each joint element consists of two different ends i.e. open end and closed end. The open end includes connectable provision preferably externally grooved/threaded portion or internally grooved/threaded socket or holes or any other connecting means to fix said open end with the joining components such as the external structures or links. The closed end includes the magnetic connector comprising of a bipolar magnet or a combination of discrete magnets disposed side by side with their opposite poles facing each other such that the outwardly facing bi-poles face opposite attracting poles of the other connecting bipolar magnetic connector.

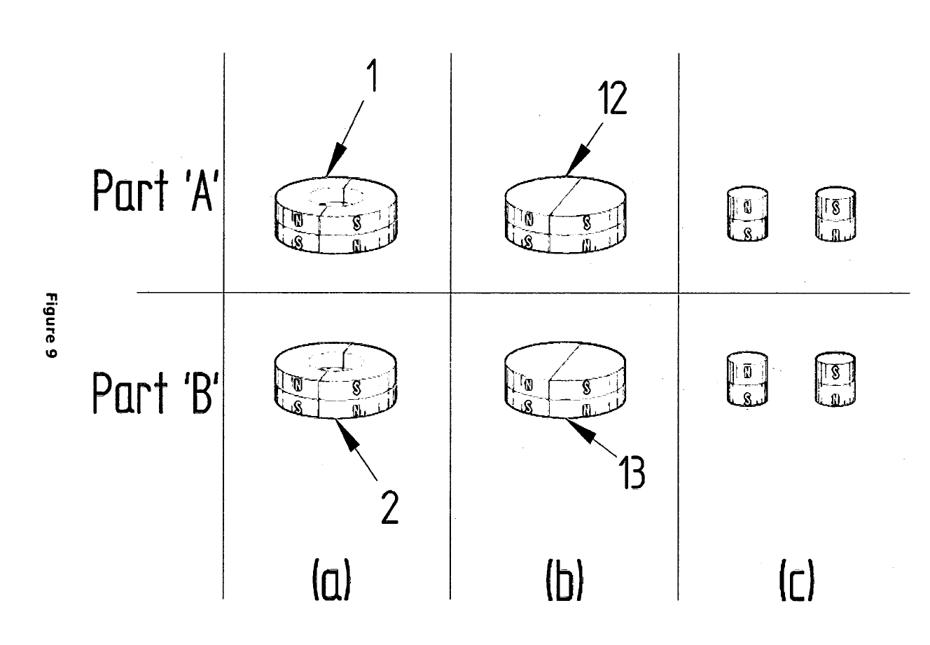

The bipolar magnetic connector of each magnetic connector comprise a pair of north and south poled magnets facing respective opposite poles obtained of single piece or multiple pieces of magnets integrally provided as a unitary piece two separate pieces of magnets with respective north and south poles facing each other in reverse orientation (shown in FIG. 9).

The first and the second joint element are connected by an elastic device such as spring in such as way that the closed end i.e. the magnetic end of each joint element faces each other. The magnetic connectors are positioned in the closed ends in a selective manner so that when the magnetic end of each joint element faces each other, the north and the south poles of the magnetic connector of one closed end lies on the south and the north poles of the magnetic connector of the other closed end and fix the joining elements to each other with the help of magnetic force of attraction at initial state.

In the present disclosure, two basic embodiments of the semi rigid joint have been disclosed viz. (i) internal spring based semi rigid joint and (ii) external spring based semi rigid joint.

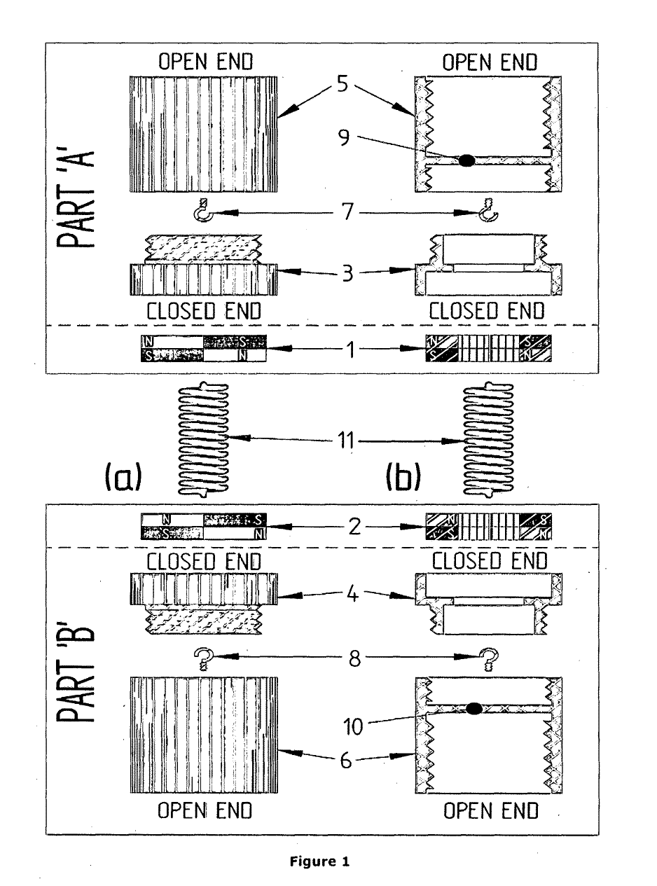

Reference is now invited from the accompanying FIGS. 1, 2 and 3 which schematically illustrate a preferred embodiment of the present internal spring based semi rigid joint. As shown in the FIG. 1, the first joint element of present internal spring based semi rigid joint embodiment is referred as part ‘A’ and the second joint element is referred as part ‘B’. The accompanying FIG. 1 clearly illustrates the open end and the closed end of each joint element. The open end includes an externally grooved/threaded portion and internally grooved/threaded socket or holes for setting screws, bolts etc. and the closed end includes the magnetic connector. These two joint elements are connected by a spring in such a way that the spring is surrounded by the magnetic connector and the closed end i.e. the magnetic end of each joint element facing each other and temporarily fixed to each other with the help of magnetic force of attraction between the magnetic connectors at initial state. In the present embodiment, to prevent slip of the joining element through joining surface, the magnetic connectors which comprising of a bipolar magnet or a combination of discrete magnets having north and south poles are adjacent to each other are positioned in the closed ends of the joining elements in a selective manner so that when the closed end of each joint element faces each other, the north and the south poles of the magnetic connector of one closed end lies on the south and the north poles of the magnetic connector of the other closed end and fix the joining elements to each other with the help of magnetic force of attraction free from any slipping. Thus positional configuration of the magnetic connectors ensure re-fixing of the detached joining elements in its original positing on release of detaching external impact/force under restored magnetic attraction of the magnetic connectors. Since the magnetic attraction of the magnetic connectors will be restored only when the north and the south pole of one magnetic connector will lie on the south and the north pole of other magnetic connector.

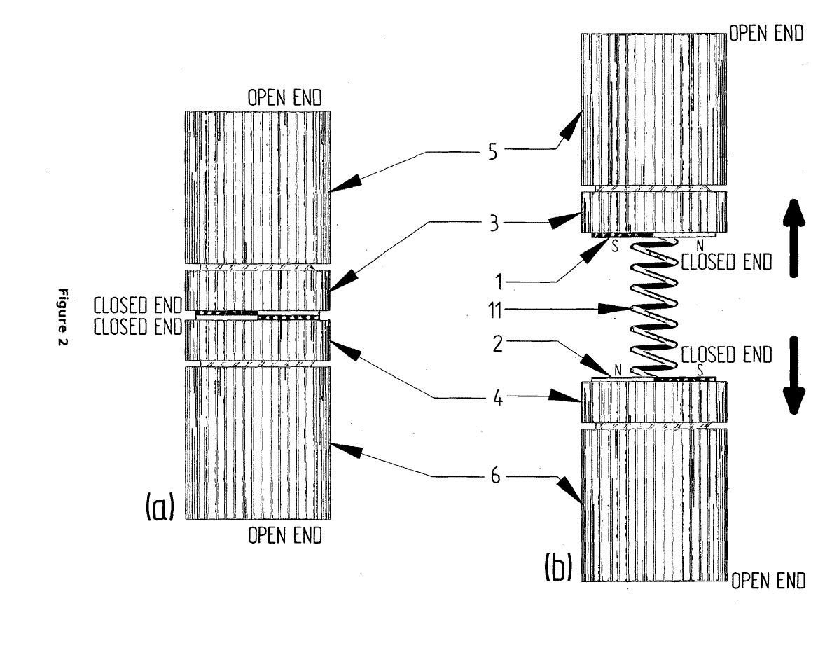

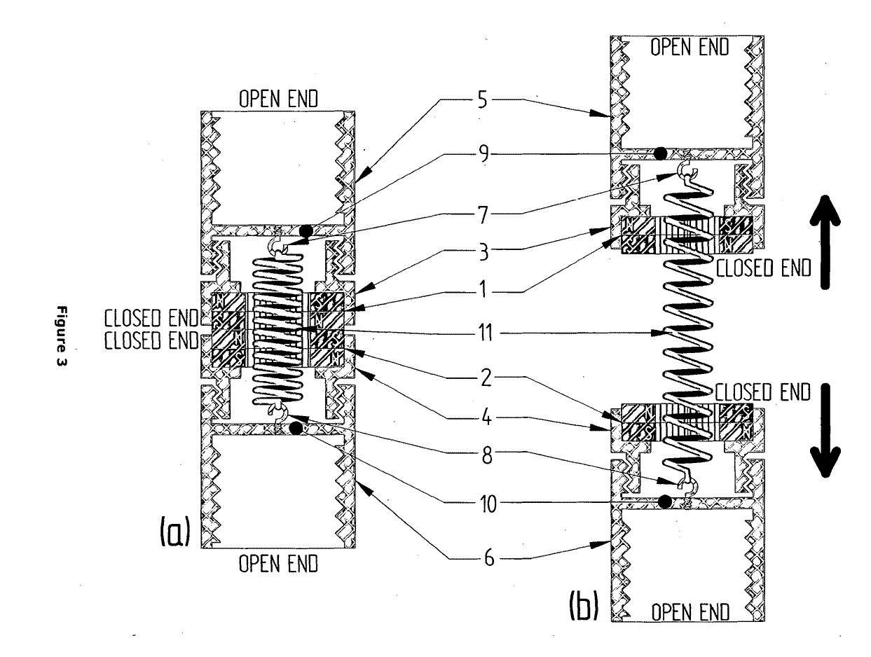

The components of the present internal spring based semi rigid joint are further illustrated in the accompanying FIGS. 2 and 3. As shown in the referred figures, in the internal spring based semi rigid joint, the magnetic connectors (1 and 2) having north and south poles are adjacent to each other are retained in magnet holder sockets (3 and 4) of the first and second joint elements.

The magnet holder sockets (3 and 4) are attached with detachable internally threaded or grooved socket (5 and 6) of the open ends of the joint elements facing towards the close ends by screw threading opposite to their socket face. Hooks (7 and 8) are attached with an internal transverse rod or screwed into the surface opposite to the open end of internal transverse plate (9 and 10 respectively) of the internally threaded or grooved sockets (5 and 6). These two hooks (7 and 8) are further connected by an extension spring 11 which is surrounded by the magnetic connectors (3 and 4).

As clearly shown in FIGS. 1, 2 and 3, the magnetic connectors (1, 2) each comprising of a bipolar magnet or a combination of discrete magnets having north and south pole adjacent to each other is selectively positioned in the magnet holder sockets (3,4) so that when the closed end of each joint element faces each other, the north and the south pole of the magnetic connector (1) lies on the south and the north pole of the magnetic connector (2) to fix the joining elements to each other with the help of magnetic force of attraction free from any slipping. Thus positional configuration of the magnetic connectors (1, 2) ensure re-fixing of the detached joining elements in its original positing on release of detaching external impact/force under restored magnetic attraction of the magnetic connectors. Since the magnetic attraction of one magnetic connectors (1, 2) will be restored only when the north and the south pole of the magnetic connector (1) will lie on the south and the north pole of other magnetic connector (2)

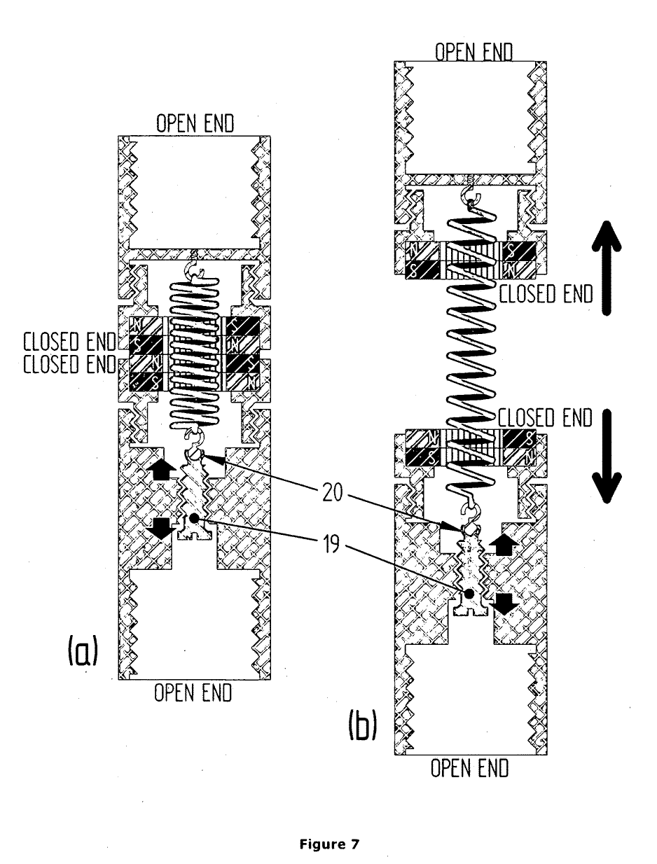

Further modification of the internal spring based semi rigid joint structure can be done according to the requirement to provide tension (manually) on the spring (11) at rigid state (initial state). The accompanying FIG. 7 illustrates such modified structure wherein a screw (19) with a ball socket joint (20) can applied to provide sliding motion along the screw (19) axis to the screw (19) in outward direction (FIG. 7a) to increase tension of the spring (11) and inward direction (FIG. 7b) to decrease tension of the spring (11).

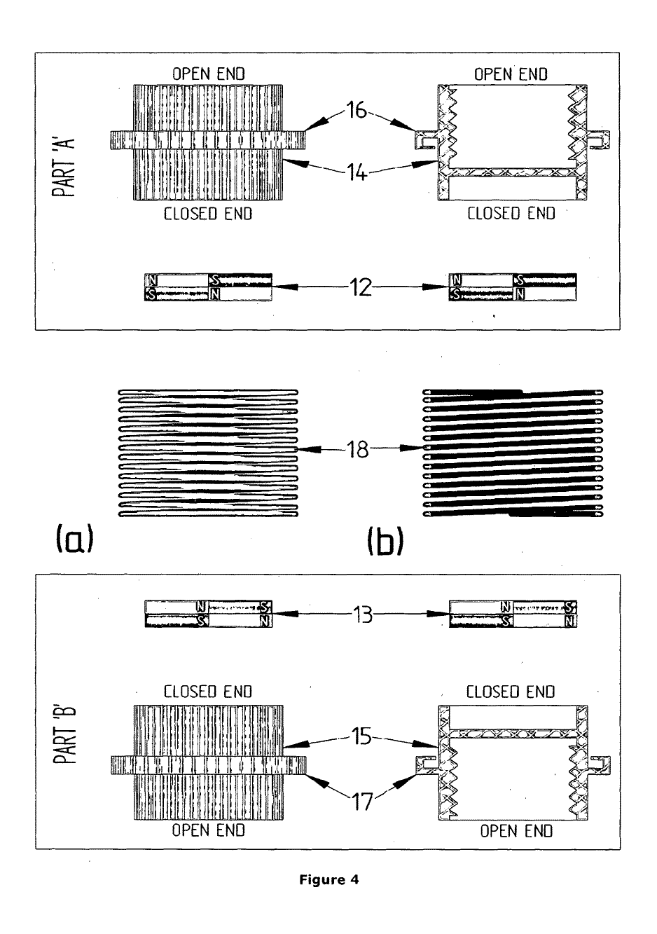

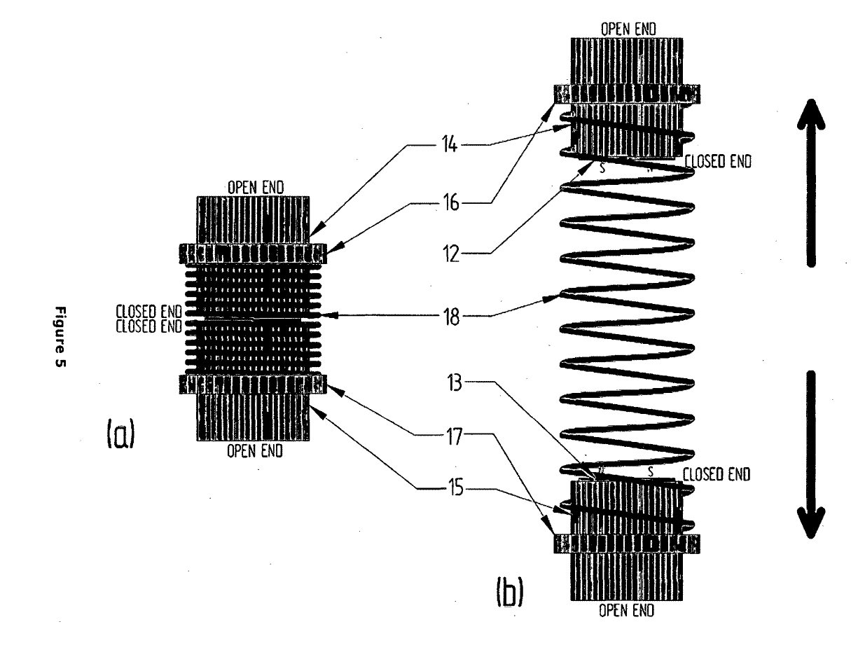

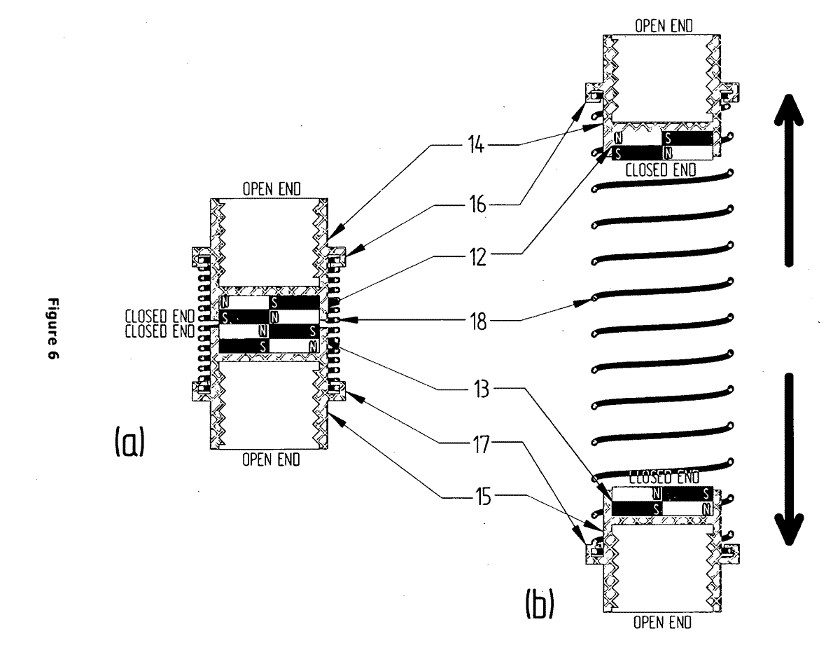

Reference is next invited from the accompanying FIGS. 4, 5 and 6 which schematically illustrate a preferred embodiment of the present external spring based semi rigid joint. The basic difference between the external spring based semi rigid joint and the internal spring based semi rigid joint is that in the external spring based semi rigid joint, the magnets are surrounded by the spring.

As referred in the accompanying FIGS. 4, 5 and 6, in the external spring based semi rigid joint, the magnetic connectors (12 and 13) comprising of a bipolar magnet or a combination of discrete magnets having north and south poles are adjacent to each other are retained in the both side sockets (14 and 15) of the closed ends, whose open ends are internally threaded or grooved. Each both side socket (14 and 15) has an attachment of spring end holder or clip (16 and 17). Two joint elements i.e. part‘ A’ and part ‘8’ are connected by an extension spring (18), whose two ends are grasped by spring end holders (16 and 17).

As clearly shown in FIGS. 4, 5 and 6, the magnetic connectors (12, 13) is selectively positioned in the side sockets (14 and 15) so that when the closed end of each joint element faces each other, the north and the south pole of one magnetic connector (12) lies on the south and the north pole of other magnetic connector (13) to fix the joining elements to each other with the help of magnetic force of attraction free from any slipping. Thus positional configuration of the magnetic connectors (12, 23) ensure re-fixing of the detached joining elements in its original positing on release of detaching external impact/force under restored magnetic attraction of the magnetic connectors. Since the magnetic attraction of the magnetic connectors (12, 13) will be restored only when the north and the south pole of one magnetic connector (12) will lie on the south and the north pole of other magnetic connector (13)

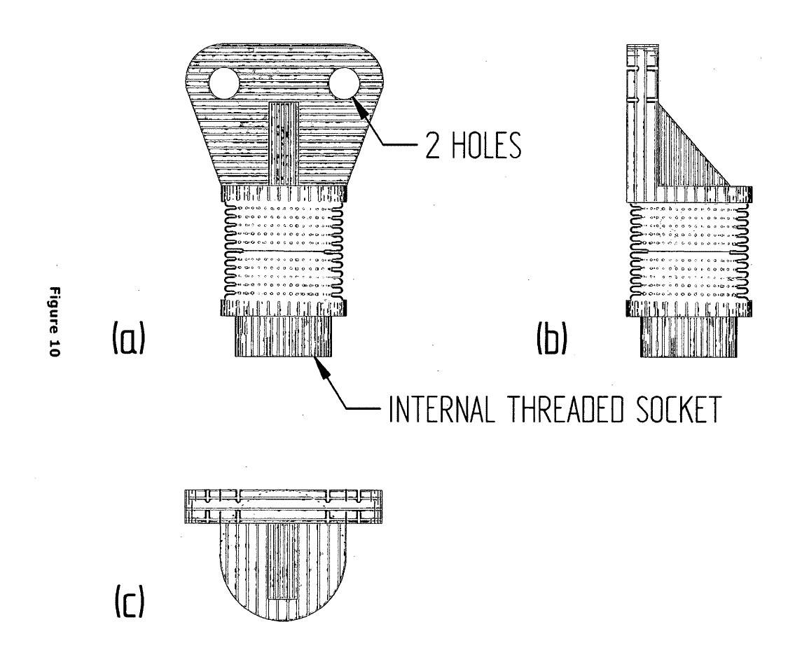

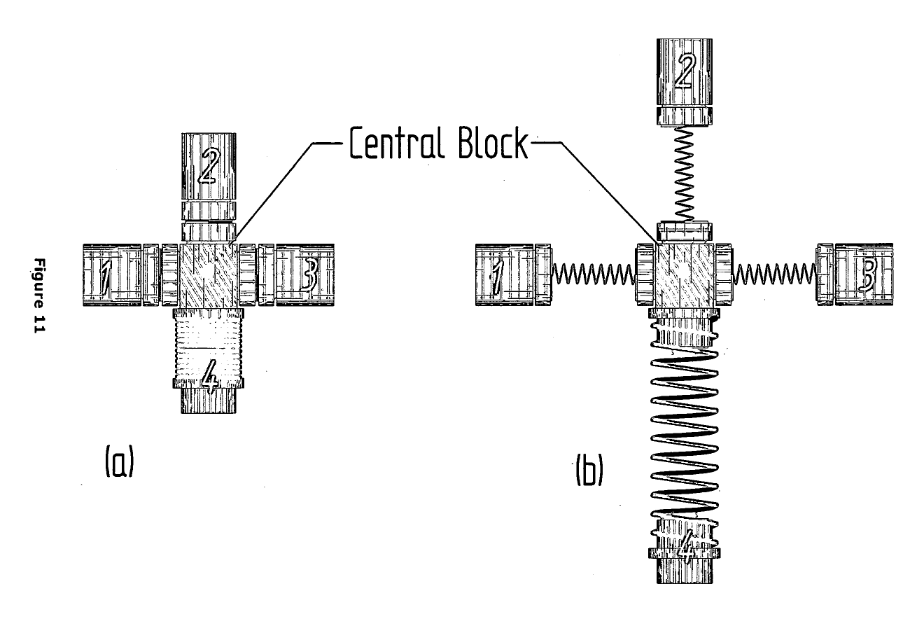

Reference is next invited from the accompanying FIG. 11, which shows a compound Semi Rigid Joint which is an assemblage of two (or more) internal spring semi rigid joint or external spring semi rigid joint or their combination. This type is highly applicable for chain formation of semi rigid joint. The compound Semi Rigid Joint embodiment as shown in the FIG. 11 involves three internal spring semi rigid joint (1, 2 and 3) and one external spring semi rigid joint (4) are connected to each other by a central block. Herein, every piece of magnet with two different poles each face can be substituted by two or more conventional magnet with alternate facing of both South and North Pole to each closed end face shown in the accompanying FIG. 9(c). Two main parts can be different in size and shape according to the requirement shown in the FIG. 10.

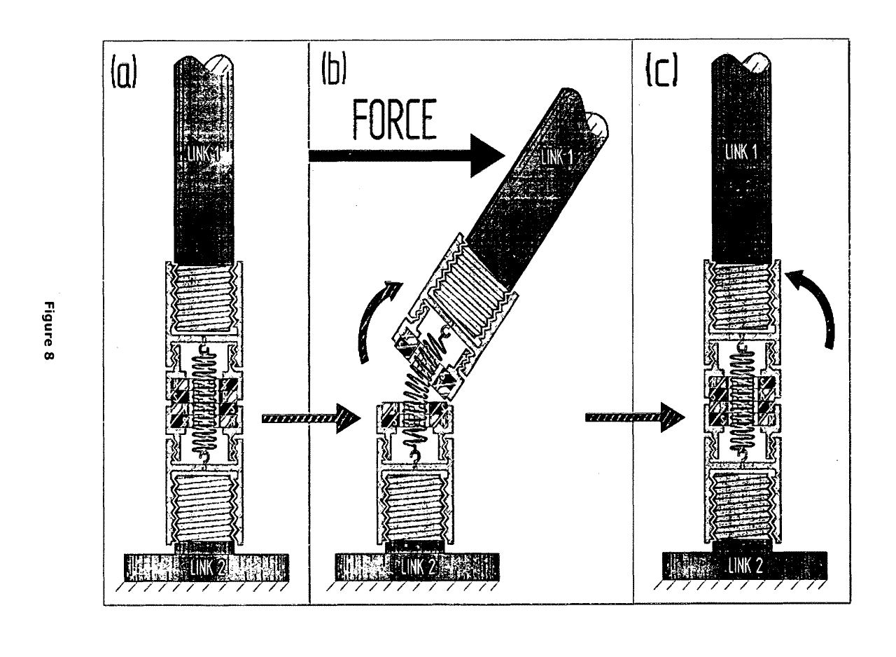

During the operation of the present semi rigid joint, when certain external force or shock, applied on the joint which exceeds its rigidity (force resistance capacity) then instead of breaking (or deforming plastically) from the joint, closed end of the two joining elements are detached from each other i.e. it gets flexible (loses its rigidity) as the magnets get loose and spring extends to absorb the force or shock shown in FIG. 8(b). When this external load is removed or the force is absorbed then the spring gets compressed to regain its previous shape FIG. 8(c) and the magnetic force of attraction of the magnetic connectors fixes the joint elements tightly like before i.e. the‘ Semi Rigid Joint’ regains its rigidity after absorbing each shock. The same joining location is secured by the use of indentation or magnets of two different poles on each surface.

The Rigidity of the joint depends upon the magnetic attraction force and compressive force of extension spring at initial state. The rigidity of the joint can be increased by simply increasing initial strain applied to the spring. So, further modification of structure can be done according to the requirement to provide tension on spring at rigid state (initial state). For example: the application of a screw with a ball socket joint can provide sliding motion (along screw axis) to the screw in outward direction to increase tension of the spring and inward direction to decrease tension of the spring.

It is thus the present semi rigid joint can lose its rigidity temporarily (gets flexible) during shock absorption period (or when effected by a certain external force which exceeds its rigidity) and after absorbing each shock (or when external force is removed or reduced) it regains its previous shape as well as rigidity, holding exactly the same position like before without undergoing any plastic deformation or breakage. In normal condition or while handling a variation of smaller load (less than a certain external force which exceeds its rigidity), it behaves like a rigid body. The present semi rigid joint not only absorbs the shock but also avoid the impact load come from any direction (except along its axis) by bending after getting flexible.

The present semi rigid joint can be used for connecting barriers with base, road divider with the road surface, electric pole or rod/pole for traffic signs or banner with a ground structure and can prevent such structures from breaking from joints upon application of the shock and certain external force.

The present semi rigid joint can also be used to build unbreakable electric pole, rod/pole for traffic signs or banner. For example, if a huge tree falls on an electric over head line then electric pole gets broken and the line wire is ruptured. But if the electric pole is made of one or more ‘Semi Rigid Joint's then line wire is not ruptured as the tension force generated in the wire is transmits to the semi rigid joint and the joint loses its rigidity as a result the upper portion of the pole temporarily bends down from that or those joints. After when the tree i.e. the load is removed then the spring gets compressed to regain its previous shape and the magnetic force of attraction fix the joint tightly like before and the ‘Semi Rigid Joint’ regains its rigidity.

While the present invention may have been described through reference to specific embodiments, the invention is not limited to these specific embodiments. Other changes and modifications known to those of ordinary skill are intended to be included within the scope of the present invention.

We claim:

1. A Semi rigid connector for flexibly joining various links/structures comprising
plurality of joining elements;
each said joining element supporting at one end at least one joining component and at its other end having a magnetic connector such that the two adjacent placed joining elements facing said respective magnetic connectors under magnetic attraction of respective magnets provide a magnetic joint to connect together the components carried at its other ends;
at least one flexible spring means in cooperation with said magnetic joint allowing bending at said magnetic joint under any external impact/force exceeding the magnetic attraction of the magnetic connectors and on release of said external impact/force rejoining the joints under restored magnetic attraction of said magnetic connectors.

2. A Semi rigid connector as claimed in claim 1, wherein said magnetic connectors comprises bipolar magnetic connector oriented such that on release of the external impact/force the bent magnetic joint regains its original orientation and connected position.

3. A Semi rigid connector as claimed in claim 2, wherein each said bipolar magnetic connector comprises a combination of magnets disposed side by side with their opposite poles facing each other such that the outwardly facing bi-poles of the bipolar magnetic connector face opposite attracting poles of the other connecting bipolar magnetic connector.

4. A Semi rigid connector as claimed in claim 3, wherein each said combination of the bipolar magnetic connector of the each magnetic connector comprise a pair of north and south poled magnets facing respective opposite poles obtained of single piece or multiple pieces of magnets integrally provided as a unitary piece two separate pieces of magnets with respective north and south poles facing each other in reverse orientation.

5. A Semi rigid connector as claimed in claim 1, wherein each of the joining elements comprises
an open end having connector provision for releasable connection/securing to a connecting component/structure;
a closed end having said magnetic connector obtained of one or more permanent magnet or a combination of magnet and magnetic material;
connecting elements comprising at least a first and a second of said joint elements which are connected under magnetic attraction of said magnetic connector at its respective closed ends and at least one spring connection at said closed ends under magnetic attraction.

6. A Semi rigid connector as claimed in claim 5, wherein each of the joining elements comprises
an open end having an externally connectable provision preferably grooved/threaded portion and an internally connectable provision preferably grooved/threaded socket or holes;
a closed end having said magnetic connector;
said first and second joint elements connectable by cooperative attraction of said respective magnetic connectors at the respective closed end and said cooperative spring attachment between said first and second joining elements wherein said spring element operatively flexibly connecting the joint at the closed end of said joining elements being provided internally and/or externally with respect to said closed end magnets.

7. A Semi rigid connector as claimed in anyone of claims 6, wherein connectable provisions at the open ends of the joint elements are used to fix the joint with external structures or links.

8. A Semi rigid connector as claimed in claim 6, wherein the magnetic connectors are oriented to prevent any slip through joining surface.

9. A Semi rigid connector as claimed in claims 1, wherein said flexible spring means connecting said joining elements are either internally connected to the joining elements or externally connected to the joining elements with cooperative connecting means in the respective joining elements.

10. A Semi rigid connector as claimed in claim 9 wherein for internally supporting the said flexible spring means between the joining elements the spring is centrally disposed within a concentrically disposed centrally open magnetic connectors of the respective joining elements and secured to a hook/support plate internally disposed and wherein for externally supporting the said flexible spring means between the joining elements the spring means surrounds the joining elements externally and is supported externally from the body of the joining elements, one end of the spring connected to one of the joining element and the other end of the spring connected to the other joining element.

11. A Semi rigid connector as claimed in claim 10 comprising internal spring based semi rigid joint structure comprising of
magnet holder sockets attached with detachable internally threaded or grooved socket of the open ends of each joint elements facing towards the close ends by screw threading opposite to their socket face;
magnets with two different poles facing each other retained in the magnet holder sockets of the joint elements;
hooks attached with an internal transverse rod or screwed into surface opposite to the open end of the internal transverse plate of the internally threaded or grooved sockets of the open ends of each joint elements;
a spring surrounded by the magnets connecting said hooks to provide the closed ends having said magnets with two different poles retained in the magnet holder sockets temporarily fixed to each other by involving the magnetic force of attraction at initial state.

12. A Semi rigid connector as claimed in claim 10, comprising external spring based semi rigid joint structure comprising of
side sockets at the closed ends of each joint elements;
magnets with different poles facing each other retained in the side sockets of the closed ends;
spring end holder or clip attachment on each side sockets;
a spring with two ends grasped by said spring end holders surrounding the magnets to provide the closed ends having said magnets with two different poles retained in the side sockets temporarily fixed to each other by involving the magnetic force of attraction at initial state.

13. A Semi rigid connector as claimed in claims 11 comprising means for building variable tension in the cooperative flexible spring depending upon the nature and/or article of the joint.

14. A Semi rigid connector as claimed in claim 13 comprises a screw with a ball socket joint slideably attached with the internal transverse plate to provide sliding motion to any of the hooks along the screw axis either in outward direction to increase tension of the spring or inward direction to decrease tension of the spring.

15. A Semi rigid connector as claimed in claim 10, comprises compound Semi Rigid Joint structure by assembling two or more internal spring based semi rigid joint structure or external spring based semi rigid joint structure or their combination.

16. A Semi rigid connector as claimed in anyone of claims 5, wherein the closed ends of the two joining elements temporarily fixed to each other by involving the magnetic force of attraction detached from each other upon application of certain external force or shock on the joint exceeding its rigidity or force resistance capacity and gets flexible by losing its rigidity as the magnets get separated and the spring extends to absorb the force or shock;
said spring gets compressed to regain its previous shape and the magnetic force of attraction fixes the joint elements rigidly upon removal of the external force or shock.

17. A Semi rigid connector as claimed in anyone of claims 1, wherein the rigidity of the joint can be increased by increasing the magnetic attraction force and/or compressive force of the spring.
